(19) United States
(12) Patent Application Publication
(10) Pub. No.: US 2024/0396133 A1
(43) Pub. Date: Nov. 28, 2024

(54) BATTERY PACK WITH SEALED SIDE-FOLDED REGION

(71) Applicant: Apple Inc., Cupertino, CA (US)

(72) Inventors: Tong Xie, Campbell, CA (US); Rui Liu, Mountain View, CA (US)

(21) Appl. No.: 18/666,353

(22) Filed: May 16, 2024

Related U.S. Application Data
(60) Provisional application No. 63/504,591, filed on May 26, 2023.

(51) Int. Cl. H01M 50/186; H01M 10/42; H01M 50/105; H01M 50/121; H01M 50/178

(52) U.S. Cl. CPC H01M 50/186; H01M 10/425; H01M 50/105; H01M 50/121; H01M 50/178; H01M 2010/4271; H01M 2220/30

(57) ABSTRACT

The disclosed technology relates to a container configured to enclose a battery cell. The container comprises a sealed region extending from a first side wall of the container and a terrace region extending from a second side wall of the container. The sealed region and the terrace region intersect in a sealed corner region located proximate to a first corner of the container. The sealed corner region is formed at an angle such that the sealed region is configured to be folded upwards along a fold line and attached to the first side wall of the container without the fold line extending into the terrace region. The first corner of the container is shaped such that the sealed region extends at least a threshold distance from the first side wall along an entire length of the sealed region.

### PRIORITY

This patent application claims the benefit under 35 U.S.C. § 119 (c) of U.S. Patent Application No. 63/504,591 entitled “Battery Pack with Sealed Side-Folded Region” and filed on May 26, 2023, which is incorporated herein by reference in its entirety.

### TECHNICAL FIELD

The present disclosure relates generally to battery packs, and more particularly, to a battery pack with a sealed side-folded region.

### BACKGROUND

Batteries packs are used to provide power to a wide variety of portable electronic devices, including laptop computers, tablet computers, mobile phones, personal digital assistants (PDAs), digital music players, watches, and wearable devices.

The battery cells of battery packs are commonly enclosed within a sealed container. Such containers may take up a lot of space within the portable electronic devices. However, improving the space efficiency of such containers may damage the seal integrity of the container and/or cause other inefficiencies during manufacture of the battery packs.

### SUMMARY

The disclosed embodiments provide for a container configured to enclose a battery cell. The container includes a sealed region extending from a first side wall of the container. The container includes a terrace region extending from a second side wall of the container. Conductive tabs are configured to extend from the battery cell through the terrace region to provide external terminals for the battery cell. The sealed region and the terrace region intersect in a sealed corner region located proximate to a first corner of the container. The sealed corner region is formed at an angle such that the sealed region is configured to be folded upwards along a fold line and attached to the first side wall of the container without the fold line extending into the terrace region. The first corner of the container is shaped such that the sealed region extends at least a threshold distance from the first side wall along an entire length of the sealed region

In some embodiments, a battery pack is disclosed. The battery pack includes a battery cell and a container enclosing the battery cell. The container includes a sealed region extending from a first side wall of the container. The container includes a terrace region extending from a second side wall of the container. Conductive tabs are configured to extend from the battery cell through the terrace region to provide external terminals for the battery cell. The sealed region and the terrace region intersect in a sealed corner region located proximate to a first corner of the container. The sealed corner region is formed at an angle such that the sealed region is configured to be folded upwards along a fold line and attached to the first side wall of the container without the fold line extending into the terrace region. The first corner of the container is shaped such that the sealed region extends at least a threshold distance from the first side wall along an entire length of the sealed region.

In some embodiments, a portable electronic device is disclosed. The portable electronic device includes a set of components powered by a battery pack and a device enclosure configured to receive the battery pack. The battery pack includes a battery cell and a container enclosing the battery cell. The container includes a sealed region extending from a first side wall of the container. The container includes a terrace region extending from a second side wall of the container. Conductive tabs are configured to extend from the battery cell through the terrace region to provide external terminals for the battery cell. The sealed region and the terrace region intersect in a sealed corner region located proximate to a first corner of the container. The scaled corner region is formed at an angle such that the sealed region is configured to be folded upwards along a fold line and attached to the first side wall of the container without the fold line extending into the terrace region. The first corner of the container is shaped such that the sealed region extends at least a threshold distance from the first side wall along an entire length of the sealed region.

### BRIEF DESCRIPTION OF THE DRAWINGS

The embodiments herein may be better understood by referring to the following description in conjunction with the accompanying drawings in which like reference numerals indicate identical or functionally similar elements. Understanding that these drawings depict only example embodiments of the disclosure and are not therefore to be considered to be limiting of its scope, the principles herein are described and explained with additional specificity and detail through the use of the accompanying drawings in which:

FIG. 1A is a first isometric view of a battery pack.

FIG. 1B is a second isometric view of the battery pack of FIG. 1A.

FIG. 2 is a third isometric view of the battery pack of FIG. 1A.

FIG. 3A is a detailed view of a connector of the battery pack of FIG. 1A.

FIG. 3B is another detailed view of the connector of the battery pack of FIG. 1A.

FIG. 4A is a first isometric view of a battery pack.

FIG. 4B is a second isometric view of the battery pack of FIG. 4A.

FIG. 5 is an isometric view of a battery pack.

FIG. 6A is a first isometric view of a battery pack.

FIG. 6B is a second isometric view of the battery pack of FIG. 6A.

FIG. 7A is a first isometric view of a battery pack.

FIG. 7B is a second isometric view of the battery pack of FIG. 7A.

FIG. 8 is a portable electronic device.

FIG. 9 illustrates an example method for manufacturing a battery pack with a sealed side-folded region.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Battery packs are used to provide power to a wide variety of portable electronic devices, including laptop computers, tablet computers, mobile phones, personal digital assistants (PDAs), digital music players, watches, and wearable devices.

The battery cells of battery packs are commonly enclosed within a sealed container (e.g., pouch). Such containers may take up a lot of space within the portable electronic devices. To improve the space efficiency of such containers, a sealed region extending from a first side wall of the container may be folded upwards and attached to the first side wall of the container.

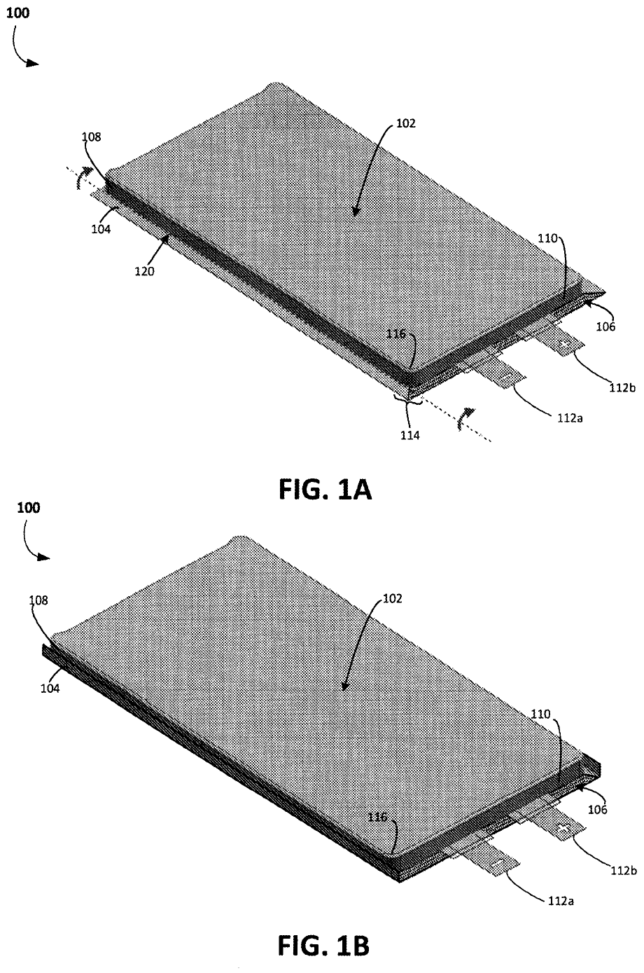

FIG. 1A is an isometric view of a battery pack 100 including a sealed region that is configured to be folded upwards and attached to the body of the container. The battery pack 100 includes a container 102. The container 102 encloses a battery cell. The container 102 may be formed of a flexible material, such as a hydrophobic polymer material, or other sufficiently flexible materials as would be known by a person of ordinary skill in the art.

The battery cell may include a set of layers. The set of layers may include a cathode with an active coating, a separator, and an anode with an active coating. For example, the cathode may be an aluminum foil coated with a lithium compound (e.g., LiCoO₂, LiNCoMn, LiCoAl or LiMn₂O₄) and the anode may be a copper foil coated with carbon or graphite. The separator may include polyethylene (PE), polypropylene (PP), and/or a combination of PE and PP, such as PE/PP or PP/PE/PP.

The set of layers may be stacked to form a stacked-cell structure. The plurality of layers may be immersed in an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The container 102 includes a sealed region 104. The sealed region 104 extends from a first side wall 108 of the container 102. The container 102 includes a terrace region 106 extending from a second side wall 110 of the container 102. Conductive tabs 112a-b can extend from the battery cell through the terrace region 106 to provide external terminals for the battery cell. The sealed region 104 and the terrace region 106 intersect in a sealed corner region 114. The sealed corner region 114 may be located proximate to a first corner 116 of the container 102.

The sealed region 104 is configured to be folded upwards along a fold line 120 and attached (e.g., glued, adhered, fixed) to the first side wall 108 of the container 102. FIG. 1B is an isometric view of the battery pack 100 having the sealed region 104 folded upwards along the fold line 120 and attached to the first side wall 108 of the container 102. Folding the scaled region 104 upwards and attaching it to the first side wall 108 of the container 102 may improve the space efficiency of the battery pack 100.

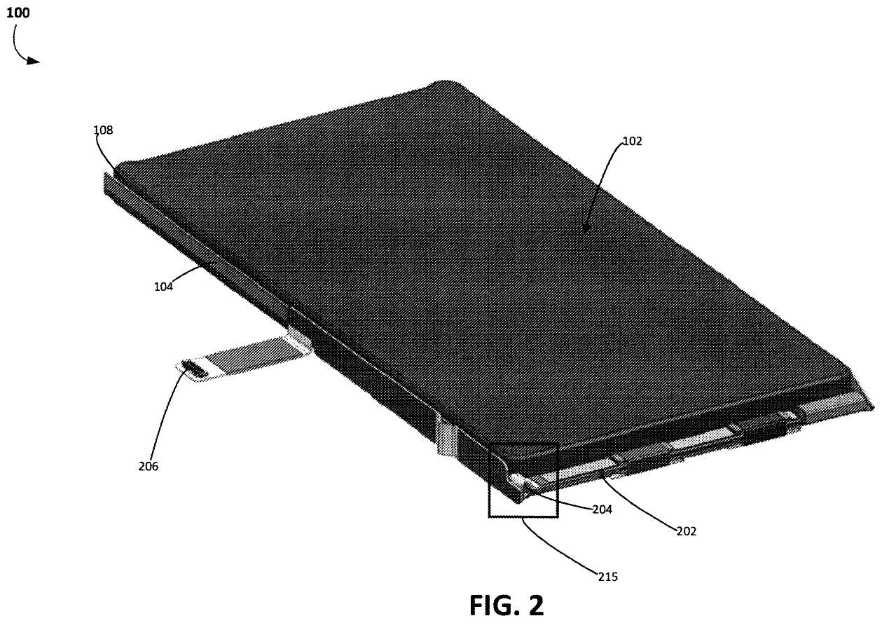

In embodiments, the battery pack 100 includes a battery management unit (BMU). FIG. 2 is a third isometric view of the battery pack 100. The container 102 is connected to (e.g., attached to) a BMU 202. The container 102 is attached to the BMU 202 on the second side wall 110 of the container 102. The BMU 202 may be connected to a main logic board (MLB) 206. The BMU 202 may be connected to a MLB 206 via a connector (e.g., flexible connector, flex, etc.) 204. A first end of the connector 204 may be attached to the BMU 202. A second end of the connector 204 may be attached to the MLB 206. The MLB 206 may extend from the first side wall 108 of the container 102.

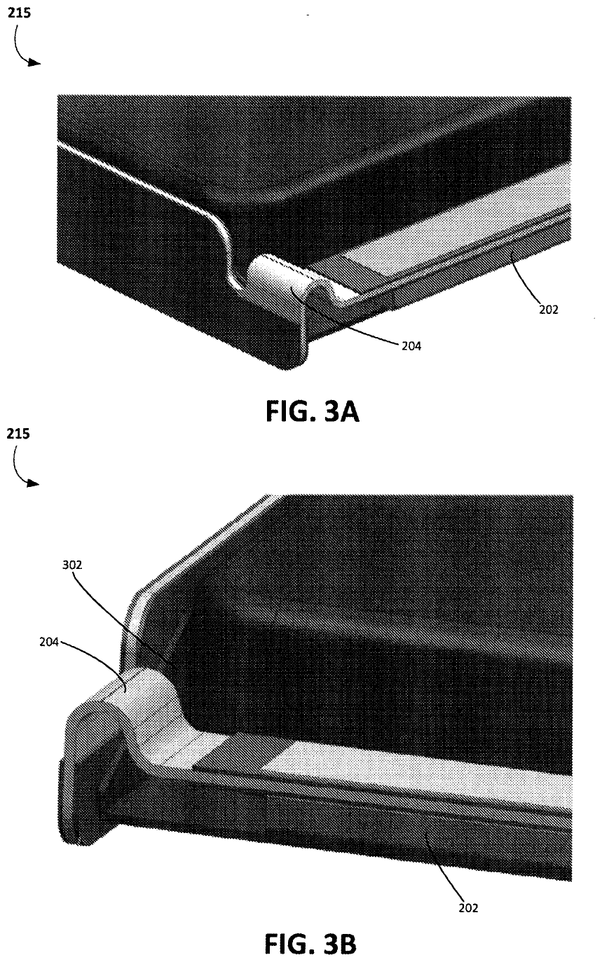

As shown in FIG. 1A, the fold line 120 extends into the terrace region 106. Thus, when the sealed region 104 is folded upwards and attached it to the first side wall 108 of the container 102, as shown in FIG. 1B, a portion of the sealed region 104 and the connector 204 may interfere in a region 215. FIGS. 3A-B are detailed views of the region 215. A first end of the connector 204 is attached to the BMU 202. A portion 302 of the sealed region 104 and the connector 204 may interfere with each other. To attach the second end of the connector 204 to the MLB 206 extending from the first side wall 108 of the container 102, the connector 204 may be configured to bend (e.g., jump) over the portion 302 of the sealed region 104.

However, configuring the connector 204 to bend over the portion 302 of the sealed region 104 may cause difficulties or inefficiencies during manufacture of the battery pack 100. Thus, while folding the sealed region 104 upwards and attaching it to the first side wall 108 of the container 102 may improve the space efficiency of the battery pack 100, the benefits of this improved space efficiency may be negated by any difficulties or inefficiencies caused by the interference between the portion 302 of the sealed region 104 and the connector 204.

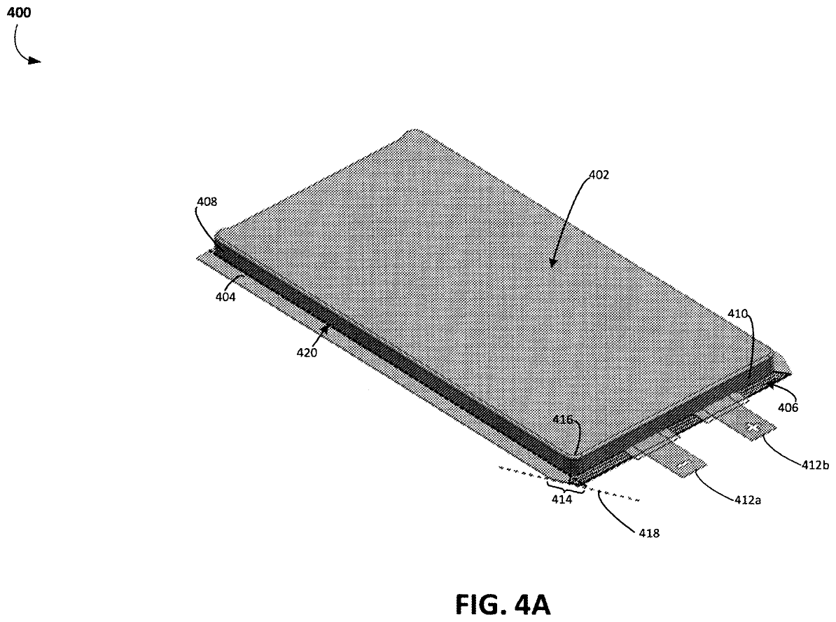

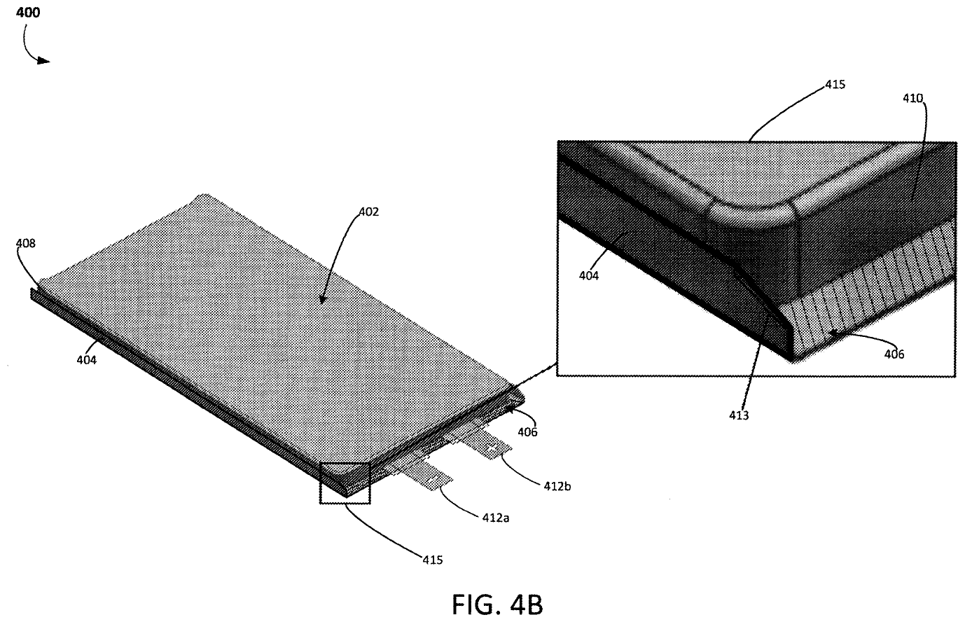

FIG. 4A is an isometric view of a battery pack 400 including a sealed region that is configured to be folded upwards and attached to the body of the container while reducing interference between the sealed region and a connector connecting the BMU to the MLB. The battery pack 400 includes a container 402. The container 402 encloses a battery cell. The container 402 may be formed of a flexible material, such as a hydrophobic polymer material, or other sufficiently flexible materials as would be known by a person of ordinary skill in the art.

The battery cell may include a set of layers. The set of layers may include a cathode with an active coating, a separator, and an anode with an active coating. For example, the cathode may be an aluminum foil coated with a lithium compound (e.g., LiCoO₂, LiNCoMn, LiCoAl or LiMn₂O₄) and the anode may be a copper foil coated with carbon or graphite. The separator may include polyethylene (PE), polypropylene (PP), and/or a combination of PE and PP, such as PE/PP or PP/PE/PP.

The set of layers may be stacked to form a stacked-cell structure. The plurality of layers may be immersed in an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The container 402 includes a sealed region 404. The sealed region 404 extends from a first side wall 408 of the container 402. The container 402 includes a terrace region 406 extending from a second side wall 410 of the container 402. Conductive tabs 412a-b can extend from the battery cell through the terrace region 406 to provide external terminals for the battery cell. The sealed region 404 and the terrace region 406 intersect in a sealed corner region 414. The sealed corner region 414 may be located proximate to a first corner 416 of the container 402. The sealed region 404 is configured to be folded upwards along a fold line 420 and attached (e.g., glued, adhered, fixed) to the first side wall 408 of the container 402.

The sealed corner region 414 can be formed (e.g., trimmed, cut) at an angle 418. If the sealed corner region 414 is formed at the angle 418, the sealed region 404 can be folded upwards along the fold line 420 and attached to the first side wall 408 of the container 402 without the fold line 420 extending as far into the terrace region 406 as the fold line 120 extends into the terrace region 106.

FIG. 4B is an isometric view of the battery pack 400 having the sealed region 404 folded upwards along the fold line 420 and attached to the first side wall 408 of the container 402. Folding the sealed region 404 upwards and attaching it to the first side wall 408 of the container 402 may improve the space efficiency of the battery pack 400. As the sealed corner region 414 is formed at the angle 418, the extension of the fold line 420 into the terrace region 406 is reduced.

As the fold line 420 does not extend as far into the terrace region 406, the amount of interference between the sealed region 404 and a connector (e.g., flexible connector, flex, etc.) may be reduced. The connector may connect a BMU attached to the second side wall 410 of the container 402 to an MLB extending from the first side wall 408 of the container 402. However, as shown in FIG. 4B, a portion 413 of the sealed region 404 may still interfere with a connector. A connector may still need to be configured to bend (e.g., jump) over the portion 413 of the sealed region 404. While the bend may be more gradual than the bend of the connector 204 shown in FIGS. 3A-B, this more gradual bend may still cause difficulties or inefficiencies during manufacture of the battery pack 400. Thus, it may be desirable to completely eliminate interference between the sealed region and a connector connecting the BMU to the MLB-thus eliminating the need to bend the connector over any portion of the sealed region.

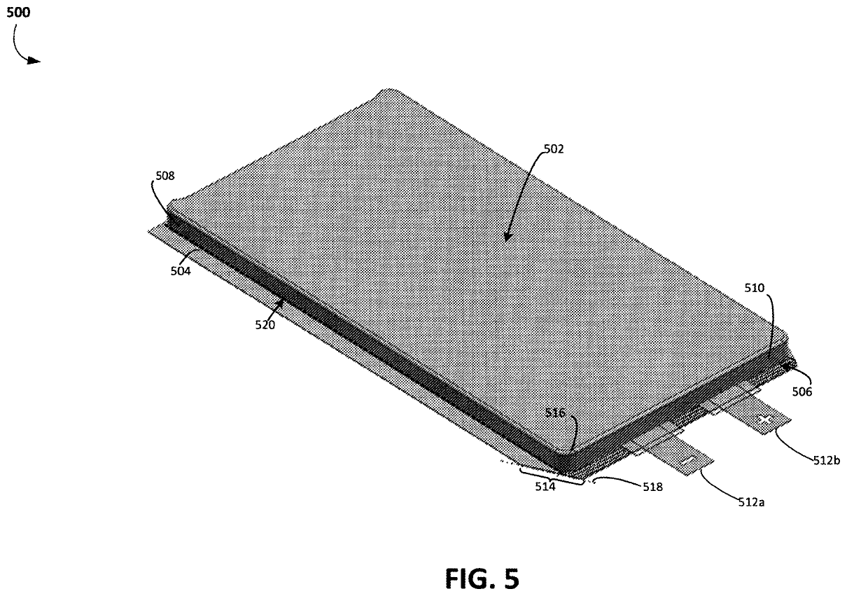

FIG. 5 is an isometric view of a battery pack 500 including a sealed region that is configured to be folded upwards and attached to the body of the container while eliminating interference between the sealed region and a connector connecting the BMU to the MLB. The battery pack 500 includes a container 502. The container 502 encloses a battery cell. The container 502 may be formed of a flexible material, such as a hydrophobic polymer material, or other sufficiently flexible materials as would be known by a person of ordinary skill in the art.

The battery cell may include a set of layers. The set of layers may include a cathode with an active coating, a separator, and an anode with an active coating. For example, the cathode may be an aluminum foil coated with a lithium compound (e.g., LiCoO₂, LiNCoMn, LiCoAl or LiMn₂O₄) and the anode may be a copper foil coated with carbon or graphite. The separator may include polyethylene (PE), polypropylene (PP), and/or a combination of PE and PP, such as PE/PP or PP/PE/PP.

The set of layers may be stacked to form a stacked-cell structure. The plurality of layers may be immersed in an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The container 502 includes a sealed region 504. The sealed region 504 extends from a first side wall 508 of the container 502. The container 502 includes a terrace region 506 extending from a second side wall 510 of the container 502. Conductive tabs 512a-b can extend from the battery cell through the terrace region 506 to provide external terminals for the battery cell. The sealed region 504 and the terrace region 506 intersect in a sealed corner region 514. The sealed corner region 514 may be located proximate to a first corner 516 of the container 502. The sealed region 504 is configured to be folded upwards along a fold line 520 and attached (e.g., glued, adhered, fixed) to the first side wall 508 of the container 502.

The sealed corner region 514 can be formed (e.g., trimmed, cut) at an angle 518. The sealed corner region 514 may be trimmed more aggressively (e.g., closer to the base of the first corner 516) than the sealed corner region 414 shown in FIGS. 4A-B. The sealed corner region 514 may be trimmed at the angle 518 such that the fold line 520 does not extend into the terrace region 506.

If the sealed corner region 514 is formed at the angle 518, the sealed region 504 can be folded upwards along the fold line 520 and attached to the first side wall 508 of the container 502 without the fold line 520 extending into the terrace region 506. As the fold line 520 does not extend into the terrace region 506, any interference between the sealed region 504 and a connector (e.g., flexible connector, flex, etc.) connecting a BMU attached to the second side wall 510 to an MLB extending from the first side wall 508 may be eliminated.

However, the aggressive trimming of the sealed corner region 514 to prevent the fold line 520 from extending into the terrace region 506 may damage the seal integrity of the sealed region 504. If the seal integrity of the sealed region 504 is damaged, liquid or moisture may be able to seep through openings in the sealed region 504 and damage the battery cell enclosed within. Accordingly, techniques for preventing the fold line 520 from extending into the terrace region 506 while maintaining the seal integrity of the sealed region 504 are desirable.

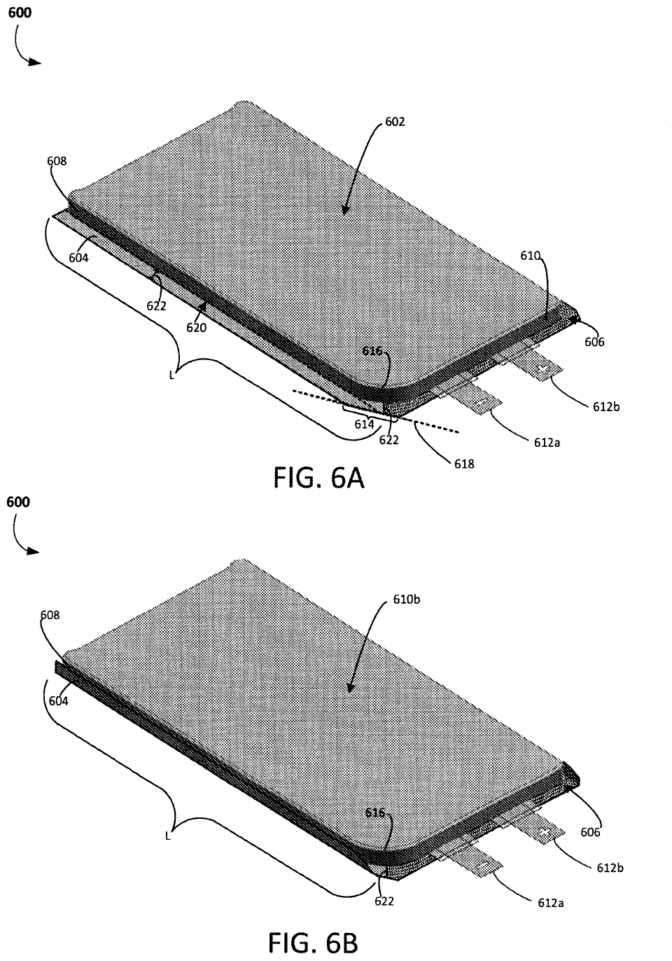

FIG. 6A is an isometric view of a battery pack 600 including a sealed region that is configured to be folded upwards and attached to the body of the container while both eliminating interference between the sealed region and a connector and maintaining the seal integrity of the sealed region. The battery pack 600 includes a container 602. The container 602 encloses a battery cell. The container 602 may be formed of a flexible material, such as a hydrophobic polymer material, or other sufficiently flexible materials as would be known by a person of ordinary skill in the art.

The battery cell may include a set of layers. The set of layers may include a cathode with an active coating, a separator, and an anode with an active coating. For example, the cathode may be an aluminum foil coated with a lithium compound (e.g., LiCoO₂, LiNCoMn, LiCoAl or LiMn₂O₄) and the anode may be a copper foil coated with carbon or graphite. The separator may include polyethylene (PE), polypropylene (PP), and/or a combination of PE and PP, such as PE/PP or PP/PE/PP.

The set of layers may be stacked to form a stacked-cell structure. The plurality of layers may be immersed in an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The container 602 includes a sealed region 604. The sealed region 604 extends from a first side wall 608 of the container 602. The container 602 includes a terrace region 606 extending from a second side wall 610 of the container 602. Conductive tabs 612a-b can extend from the battery cell through the terrace region 606 to provide external terminals for the battery cell. The sealed region 604 and the terrace region 606 intersect in a sealed corner region 614. The sealed corner region 614 may be located proximate to a first corner 616 of the container 602. The sealed region 604 is configured to be folded upwards along a fold line 620 and attached (e.g., glued, adhered, fixed) to the first side wall 608 of the container 602.

The sealed corner region 614 can be formed (e.g., trimmed, cut) at an angle 618. The sealed corner region 614 may be trimmed at the angle 618 such that the fold line 620 does not extend into the terrace region 606. If the sealed corner region 614 is formed at the angle 618, the sealed region 604 can be folded upwards along the fold line 620 and attached to the first side wall 608 of the container 602 without the fold line 620 extending into the terrace region 606.

In embodiments, a BMU is connected to the second side wall 610 of the container 602. The BMU can be connected to an MLB extending from the first side wall 608 of the container 602 via a connector (e.g., flexible connector, flex, etc.). As the fold line 620 does not extend into the terrace region 606, any interference or overlap between the sealed region 604 and the connector may be eliminated. In particular, the sealed region 604 may be folded upwards along the fold line 620 and attached to the first side wall of the container without the connector overlapping with any portion of the sealed region 604 in the sealed corner region 614.

However, the aggressive trimming of the sealed corner region 614 to prevent the fold line 620 from extending into the terrace region 606 may damage the seal integrity of the sealed region 604. If the seal integrity of the sealed region 604 is damaged, liquid or moisture may be able to seep through openings in the sealed region 604 and damage the battery cell enclosed within.

To prevent this damage to the seal integrity of the sealed region 604, the first corner 616 of the container 602 can be shaped such that the sealed region 604 extends at least a threshold distance 622 from a base of the first side wall 608 along an entire length L of the sealed region 604. The threshold distance can be 0.5 millimeters, 1 millimeter, 1.5 millimeters, 2 millimeters or any other suitable distance that can maintain the seal integrity of the sealed region 604. Ensuring that the sealed region 604 extends at least a threshold distance 622 from a base of the first side wall 608 along an entire length L of the sealed region 604 may protect the seal integrity of the sealed region 604. Thus, the sealed region 604 may not include any openings through which liquid or moisture can seep through and damage the battery cell enclosed within.

The first corner 616 of the container 602 can be shaped into a rounded corner, for example. Shaping the first corner 616 of the container 602 into a rounded corner allows the scaled corner region 614 to be trimmed aggressively enough to prevent the fold line 620 from extending into the terrace region 606 while ensuring that the sealed region 604 extends at least the threshold distance 622 from the base of the first side wall 608 along the entire length L of the sealed region 604.

In embodiments, the battery cell enclosed within the container 602 may be formed in a shape corresponding to a shape of the container 602. If the first corner 616 of the container 602 is shaped into a rounded corner, at least one corner of the set of layers may be formed (e.g., trimmed, cut) into a similar rounded corner. Forming at least one corner of the set of layers at into substantially the same shape as the first corner 616 of the container 602 may ensure that the battery cell fits properly within the container 602.

FIG. 6B is an isometric view of the battery pack 600 having the sealed region 604 folded upwards along the fold line 620 and attached to the first side wall 608 of the container 602. Folding the sealed region 604 upwards and attaching it to the first side wall 608 of the container 602 may improve the space efficiency of the battery pack 600.

As the sealed corner region 614 is formed at the angle 618, the fold line 620 does not extend into the terrace region 606. As the fold line 620 does not extend into the terrace region 606, interference (e.g., overlap) between the sealed region 604 and a connector (e.g., flexible connector, flex, etc.) connecting a BMU attached to the second side wall 410 to an MLB extending from the first side wall 408 is prevented. Shaping the first corner 616 of the container 602 into a rounded corner allows the sealed corner region 614 to be trimmed aggressively enough to prevent the fold line 620 from extending into the terrace region 606 while ensuring that the sealed region 604 extends at least the threshold distance 622 from the base of the first side wall 608 along the entire length L of the sealed region 604.

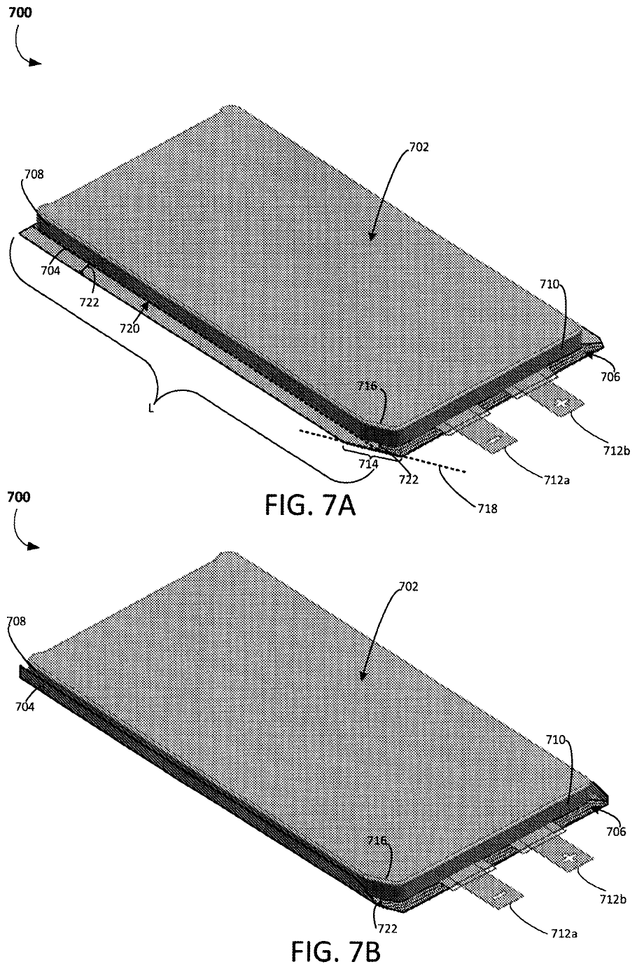

FIG. 7A is an isometric view of a battery pack 700 including a sealed region that is configured to be folded upwards and attached to the body of the container while both eliminating interference between the sealed region and a connector and maintaining the seal integrity of the sealed region. The battery pack 700 includes a container 702. The container 702 encloses a battery cell. The container 702 may be formed of a flexible material, such as a hydrophobic polymer material, or other sufficiently flexible materials as would be known by a person of ordinary skill in the art.

The battery cell may include a set of layers. The set of layers may include a cathode with an active coating, a separator, and an anode with an active coating. For example, the cathode may be an aluminum foil coated with a lithium compound (e.g., LiCoO₂, LiNCoMn, LiCoAl or LiMn₂O₄) and the anode may be a copper foil coated with carbon or graphite. The separator may include polyethylene (PE), polypropylene (PP), and/or a combination of PE and PP, such as PE/PP or PP/PE/PP.

The set of layers may be stacked to form a stacked-cell structure. The plurality of layers may be immersed in an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The container 702 includes a sealed region 704. The sealed region 704 extends from a first side wall 708 of the container 702. The container 702 includes a terrace region 706 extending from a second side wall 710 of the container 702. Conductive tabs 712a-b can extend from the battery cell through the terrace region 706 to provide external terminals for the battery cell. The sealed region 704 and the terrace region 706 intersect in a sealed corner region 714. The sealed corner region 714 may be located proximate to a first corner 716 of the container 702. The sealed region 704 is configured to be folded upwards along a fold line 720 and attached (e.g., glued, adhered, fixed) to the first side wall 708 of the container 702.

The sealed corner region 714 can be formed (e.g., trimmed, cut) at an angle 718. The scaled corner region 714 may be trimmed at the angle 718 such that the fold line 720 does not extend into the terrace region 706. If the sealed corner region 714 is formed at the angle 718, the sealed region 704 can be folded upwards along the fold line 720 and attached to the first side wall 708 of the container 702 without the fold line 720 extending into the terrace region 706.

In embodiments, a BMU is connected to the second side wall 710 of the container 702. The BMU can be connected to an MLB extending from the first side wall 708 of the container 702 via a connector (e.g., flexible connector, flex, etc.). As the fold line 720 does not extend into the terrace region 706, any interference or overlap between the sealed region 704 and the connector may be eliminated. In particular, the sealed region 704 may be folded upwards along the fold line 720 and attached to the first side wall of the container without the connector overlapping with any portion of the sealed region 704 in the sealed corner region 714.

However, the aggressive trimming of the sealed corner region 714 to prevent the fold line 720 from extending into the terrace region 706 may damage the seal integrity of the sealed region 704. If the seal integrity of the sealed region 704 is damaged, liquid or moisture may be able to seep through openings in the sealed region 704 and damage the battery cell enclosed within.

To prevent this damage to the seal integrity of the sealed region 704, the first corner 716 of the container 702 can be shaped such that the sealed region 704 extends at least a threshold distance 722 from a base of the first side wall 708 along an entire length L of the sealed region 704. The threshold distance can be 0.5 millimeters, 1 millimeter, 1.5 millimeters, 2 millimeters or any other suitable distance that can maintain the seal integrity of the sealed region 704. Ensuring that the sealed region 704 extends at least a threshold distance 722 from a base of the first side wall 708 along an entire length L of the sealed region 704 may protect the seal integrity of the sealed region 704. Thus, the sealed region 704 may not include any openings through which liquid or moisture can seep through and damage the battery cell enclosed within.

The first corner 716 of the container 702 can be shaped into a diagonal chamfer corner, for example. The diagonal chamfer corner may be formed at the angle 718 such that the diagonal chamfer corner is positioned parallel to the trimmed sealed corner region 714. Shaping the first corner 716 of the container 702 into a diagonal chamfer corner allows the sealed corner region 714 to be trimmed aggressively enough to prevent the fold line 720 from extending into the terrace region 706 while ensuring that the sealed region 704 extends at least the threshold distance 722 from the base of the first side wall 708 along the entire length L of the sealed region 704.

In embodiments, the battery cell enclosed within the container 702 may be formed in a shape corresponding to a shape of the container 702. If the first corner 716 of the container 702 is shaped into a diagonal chamfer corner, at least one corner of the set of layers may be formed (e.g., trimmed, cut) into a similar diagonal chamfer corner. Forming at least one corner of the set of layers at into substantially the same shape as the first corner 716 of the container 702 may ensure that the battery cell fits properly within the container 702.

FIG. 7B is an isometric view of the battery pack 700 having the sealed region 704 folded upwards along the fold line 720 and attached to the first side wall 708 of the container 702. Folding the sealed region 704 upwards and attaching it to the first side wall 708 of the container 702 may improve the space efficiency of the battery pack 700.

As the sealed corner region 714 is formed at the angle 718, the fold line 720 does not extend into the terrace region 706. As the fold line 720 does not extend into the terrace region 706, interference (e.g., overlap) between the sealed region 704 and a connector (e.g., flexible connector, flex, etc.) connecting a BMU attached to the second side wall 410 to an MLB extending from the first side wall 408 is prevented. Shaping the first corner 716 of the container 702 into a diagonal chamfer corner allows the sealed corner region 714 to be trimmed aggressively enough to prevent the fold line 720 from extending into the terrace region 706 while ensuring that the sealed region 704 extends at least the threshold distance 722 from the base of the first side wall 708 along the entire length L of the sealed region 704.

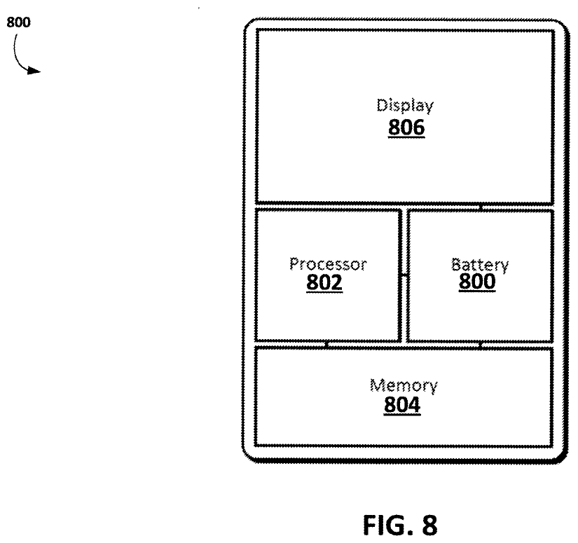

FIG. 8 illustrates a portable electronic device 800, in accordance with various aspects of the subject technology. The battery pack 600 and/or the battery pack 700 can generally be used in any type of electronic device. For example, FIG. 8 illustrates a portable electronic device 800 which includes a processor 802, a memory 804 and a display 806, which are all powered by the battery pack 600 and/or the battery pack 700. Portable electronic device 800 may correspond to a laptop computer, tablet computer, mobile phone, personal digital assistant (PDA), digital music player, watch, and wearable device, and/or other type of battery-powered electronic device.

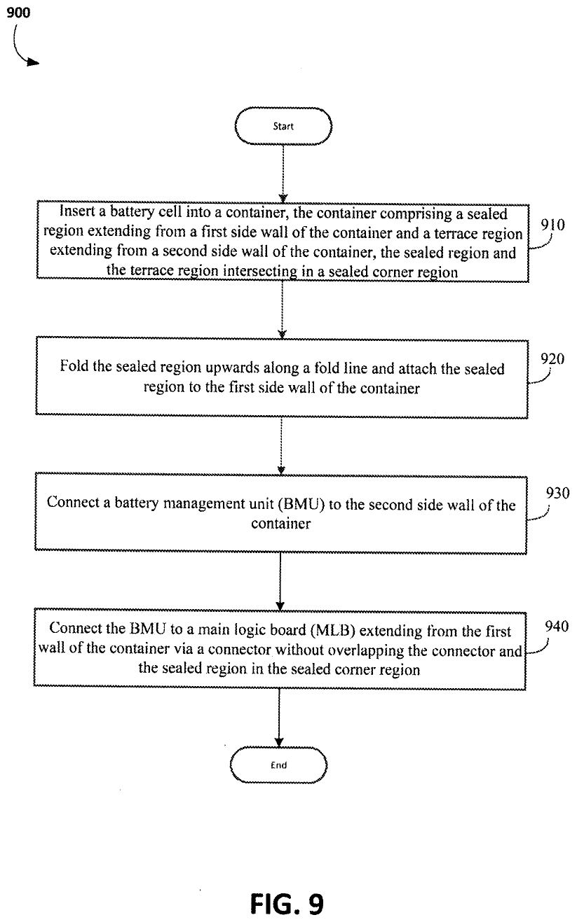

FIG. 9 illustrates an example method 900 for manufacturing the battery pack 600 and/or the battery pack 700, in accordance with various aspects of the subject technology. It should be understood that, for any process discussed herein, there can be additional, fewer, or alternative steps performed in similar or alternative orders, or in parallel, within the scope of the various embodiments unless otherwise stated.

At operation 910, a battery cell may be inserted into a container (e.g., the container 602 or the container 702). The container can be a hydrophobic polymer material. The container includes a sealed region (e.g., the sealed region 604 or the sealed region 704) extending from a first side wall of the container and a terrace region (e.g., the terrace region 606 or the terrace region 706) extending from a second side wall of the container. Conductive tabs can extend from the battery cell through the terrace region to provide external terminals for the battery cell. The sealed region and the terrace region intersect in a sealed corner region (e.g., the sealed corner region 614 or the sealed corner region 714). The sealed corner region may be located proximate to a first corner (e.g., the first corner 616 or the first corner 716) of the container.

The sealed corner region can be formed (e.g., trimmed, cut) at an angle (e.g., the angle 618 or the angle 718). The sealed corner region may be formed at the angle such that a fold line associated with the sealed region does not extend into the terrace region. If the sealed corner region is formed at the angle, the sealed region can be folded upwards along the fold line and attached to the first side wall of the container without the fold line extending into the terrace region.

The first corner of the container can be shaped such that the sealed region extends at least a threshold distance from the first side wall along an entire length of the sealed region. The threshold distance can be 0.5 millimeters, 1 millimeter, 1.5 millimeters, 2 millimeters, and/or any other suitable distance. In embodiments, the first corner of the container is shaped into a rounded corner. In other embodiments, the first corner of the container is shaped into a diagonal chamfer corner. The diagonal chamfer corner can be formed at the angle such that the diagonal chamfer corner is positioned parallel to the sealed corner region.

At operation 920, the sealed region may be folded upwards along a fold line and attached to the first side wall of the container.

At operation 930, a battery management unit (BMU) may be connected to the second side wall of the container. At operation 940, the BMU may be connected to a main logic board (MLB). The MLB may extend from the first wall of the container. The BMU may be connected to the MLB via a connector without overlapping the connector and the sealed region in the sealed corner region. As the fold line does not extend into the terrace region, any interference or overlap between the sealed region and the connector may be eliminated. In particular, the sealed region may be folded upwards along the fold line and attached to the first side wall of the container without the connector overlapping with any portion of the sealed region in the sealed corner region.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A container configured to enclose a battery cell, the container comprising:
a sealed region extending from a first side wall of the container; and
a terrace region extending from a second side wall of the container, wherein conductive tabs are configured to extend from the battery cell through the terrace region to provide external terminals for the battery cell,
wherein the sealed region and the terrace region intersect in a sealed corner region located proximate to a first corner of the container, wherein the sealed corner region is formed at an angle such that the sealed region is configured to be folded upwards along a fold line and attached to the first side wall of the container without the fold line extending into the terrace region, and
wherein the first corner of the container is shaped such that the sealed region extends at least a threshold distance from the first side wall along an entire length of the sealed region.

2. The container of claim 1, wherein the first corner of the container is shaped into a rounded corner or a diagonal chamfer corner.

3. The container of claim 2, wherein the diagonal chamfer corner is formed at the angle such that the diagonal chamfer corner is positioned parallel to the sealed corner region.

4. The container of claim 1, wherein the threshold distance is 1 millimeter.

5. The container of claim 1, wherein the container is a hydrophobic polymer material.

6. The container of claim 1, wherein a battery management unit (BMU) is connected to the second side wall of the container, and wherein the BMU is connected to a main logic board (MLB) extending from the first side wall of the container via a connector.

7. The container of claim 6, wherein the sealed region is further configured to be folded upwards along the fold line and attached to the first side wall of the container without the connector overlapping with the sealed region in the sealed corner region.

8. A battery pack comprising:
a battery cell; and
a container enclosing the battery cell, the container comprising:
a sealed region extending from a first side wall of the container; and
a terrace region extending from a second side wall of the container,
wherein conductive tabs are configured to extend from the battery cell through the terrace region to provide external terminals for the battery cell,
wherein the sealed region and the terrace region intersect in a sealed corner region located proximate to a first corner of the container, wherein the sealed corner region is formed at an angle such that the sealed region is configured to be folded upwards along a fold line and attached to the first side wall of the container without the fold line extending into the terrace region, and
wherein the first corner of the container is shaped such that the sealed region extends at least a threshold distance from the first side wall along an entire length of the sealed region.

9. The battery pack of claim 8, wherein the first corner of the container is shaped into a rounded corner or a diagonal chamfer corner.

10. The battery pack of claim 9, wherein the diagonal chamfer corner is formed at the angle such that the diagonal chamfer corner is positioned parallel to the sealed corner region.

11. The battery pack of claim 8, wherein the threshold distance is 1 millimeter.

12. The battery pack of claim 8, wherein the container is a hydrophobic polymer material.

13. The battery pack of claim 8, wherein a battery management unit (BMU) is connected to the second side wall of the container, and wherein the BMU is connected to a main logic board (MLB) extending from the first side wall of the container via a connector.

14. The battery pack of claim 13, wherein the sealed region is further configured to be folded upwards along the fold line and attached to the first side wall of the container without the connector overlapping with the sealed region in the sealed corner region.

15. A portable electronic device comprising:
a set of components powered by a battery pack; and
a device enclosure configured to receive the battery pack, the battery pack comprising:
a battery cell; and
a container enclosing the battery cell, the container comprising:
a sealed region extending from a first side wall of the container; and
a terrace region extending from a second side wall of the container,
wherein conductive tabs are configured to extend from the battery cell through the terrace region to provide external terminals for the battery cell,
wherein the sealed region and the terrace region intersect in a sealed corner region located proximate to a first corner of the container, wherein the sealed corner region is formed at an angle such that the sealed region is configured to be folded upwards along a fold line and attached to the first side wall of the container without the fold line extending into the terrace region, and
wherein the first corner of the container is shaped such that the sealed region extends at least a threshold distance from the first side wall along an entire length of the sealed region.

16. The portable electronic device of claim 15, wherein the first corner of the container is shaped into a rounded corner or a diagonal chamfer corner.

17. The portable electronic device of claim 16, wherein the diagonal chamfer corner is formed at the angle such that the diagonal chamfer corner is positioned parallel to the sealed corner region.

18. The portable electronic device of claim 15, wherein the threshold distance is 1 millimeter.

19. The portable electronic device of claim 15, wherein the container is a hydrophobic polymer material.

20. The portable electronic device of claim 15, wherein a battery management unit (BMU) is connected to the second side wall of the container, and wherein the BMU is connected to a main logic board (MLB) extending from the first side wall of the container via a connector, and
wherein the sealed region is further configured to be folded upwards along the fold line and attached to the first side wall of the container without the connector overlapping with the sealed region in the sealed corner region.
